(19) United States
(12) Patent Application Publication
(10) Pub. No.: US 2026/0274356 A1
(43) Pub. Date: Sep. 17, 2026

(54) FOLDABLE TRAILER WITH A LOCKING SYSTEM

(71) Applicant: Troy Shockley, Greenville, SC (US)

(72) Inventor: Troy Shockley, Greenville, SC (US)

(21) Appl. No.: 19/078,564

(22) Filed: Mar. 13, 2025

(51) Int. Cl. B62D 63/06; B60P 1/43; B60P 3/077

(52) U.S. Cl. CPC B62D 63/061; B60P 1/433; B60P 3/077

(57) ABSTRACT

A foldable trailer design with an incorporated locking system for enhanced portability and storage efficiency. The trailer features a primary frame with a platform and a secondary frame with a platform, where the secondary frame is hinged to fold onto the primary frame. A locking support structure secures the trailer in its folded position and provides support when the trailer is upright. Two embodiments of the locking support structure utilize pins or other mechanisms to lock/unlock the secondary frame. The design may incorporate caster wheels for maneuverability when folded and features like wheel chocks for securing transported vehicles. The disclosed foldable trailer offers a practical solution for space-saving storage and convenient transportation of various cargo.

### TECHNICAL FIELD

This invention disclosed herein relates generally to the field of trailers. Specifically, foldable trailers and system for locking foldable trailers for enhanced portability and storage efficiency.

### BACKGROUND

Foldable trailers have long been sought after for their space-saving benefits, particularly in environments where storage space is limited. Early designs often relied on locking methods, such as rubber latches, to secure the trailer in its folded position. These systems are prone to deterioration and susceptible to accidental unlocking. Thus, there is a need and demand of improvement to these types of foldable trailers.

### SUMMARY

The following simplified summary provides a basic understanding of some aspects of the claimed subject matter. This summary is not an extensive overview and is not intended to identify key/critical elements or to delineate the scope of the claimed subject matter. Its purpose is to present some concepts in a simplified form as a prelude to the more detailed description that is presented below.

One object of the invention is to provide an improved foldable trailer that includes a locking support structure. The locking support structure may also aid in supporting the trailer when placed upright. In one embodiment, the locking support structure is a rotatable member that is attached to a hinge face portion of the frame of the foldable trailer. The rotatable member is configured to be rotatable from a first position (locked position) and second position (unlocked position). The rotatable member may also include a swivel caster that is capable of rotating 360°. In one embodiment, the locking support structure is a removable member that is attached to a hinge face portion of the frame of the foldable trailer via locking pins.

According to one embodiment a foldable trailer is disclosed. The foldable trailer comprises a primary frame and a primary platform attached to the primary frame, wherein the primary frame includes a forward primary frame member, a rear lateral primary frame member, and a rear vertical primary frame member, wherein the forward primary frame member is configured to attach to a vehicle trailer hitch. A secondary frame and a secondary platform attached to the secondary frame, wherein the secondary frame includes a forward lateral secondary frame member, where the forward lateral secondary frame member is parallel to the rear vertical primary frame member. A hinge connected to the rear vertical primary frame member and the forward lateral secondary frame member thereby connecting the primary frame and the secondary frame, wherein the secondary frame folds onto the primary frame. A locking support structure comprising swivel caster attached to a main body, wherein said locking support structure configured to be fastened onto the rear vertical primary frame member portion at said end on a first end of the of the locking support structure and wherein said locking support structure is configured to lock the secondary frame by abutting the forward lateral secondary frame member and unlock the second portion by adjusting the main body away from the forward lateral secondary frame member. The locking support structure configured to support the primary and secondary frame and allows the foldable trailer to be movable when the foldable trailer is upright.

According to another embodiment a foldable trailer is disclosed herein. The foldable trailer comprising a primary frame and a primary platform attached to the primary frame, wherein the primary frame includes a forward primary frame member, a first rear lateral primary frame member, a second rear lateral primary frame member and a rear vertical primary frame member extending between the first rear lateral and the second rear lateral primary frame members, wherein the forward primary frame member is configured to attach to a vehicle trailer hitch. A secondary frame and a secondary platform attached to the secondary frame, wherein the secondary frame includes a first forward lateral secondary frame member, a second forward lateral secondary frame member. A hinge connected to the first rear vertical primary frame member and the first forward lateral secondary frame member thereby connecting the primary frame and the secondary frame, wherein the secondary frame folds onto the primary frame. A locking support structure comprising swivel caster attached to a main body, wherein said locking support structure configured to be fastened onto the rear vertical primary frame member portion at said end on a first end of the of the locking support structure and extend towards the second forward lateral secondary frame member, wherein said locking support structure is configured to lock the secondary frame by abutting the second forward lateral secondary frame member and unlock the second portion by adjusting the main body away from the second forward lateral secondary frame member. The locking support structure configured to support the primary and secondary frame and allows the foldable trailer to be movable when the foldable trailer is upright.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a top isometric view of a simplified foldable trailer.

FIG. 2 is a front isometric view of the simplified foldable trailer in the folded configuration in the upright position.

FIG. 3 is a top isometric view of the simplified foldable trailer in the folded configuration

FIG. 4A is a detailed view of the rear of the foldable trailer in its folded configuration with a locking system in its locked stated.

FIG. 4B is a detailed view of the rear of the foldable trailer in its folded configuration with a locking system in its unlocked state.

FIG. 5A is a detailed view of the rear of the foldable trailer in its folded configuration with a locking system in its locked state according to another embodiment.

FIG. 5B is a detailed view of the rear of the foldable trailer in its folded configuration with a locking system in its unlocked state according to another embodiment.

FIG. 6 is a detailed view of a locking support structure according to another embodiment.

FIG. 7 is a rear view of the foldable trailer according to one embodiment.

FIG. 8 is a rear view of the foldable trailer according to one embodiment.

FIG. 9 is a rear view of the foldable trailer according to one embodiment.

### DETAILED DESCRIPTION

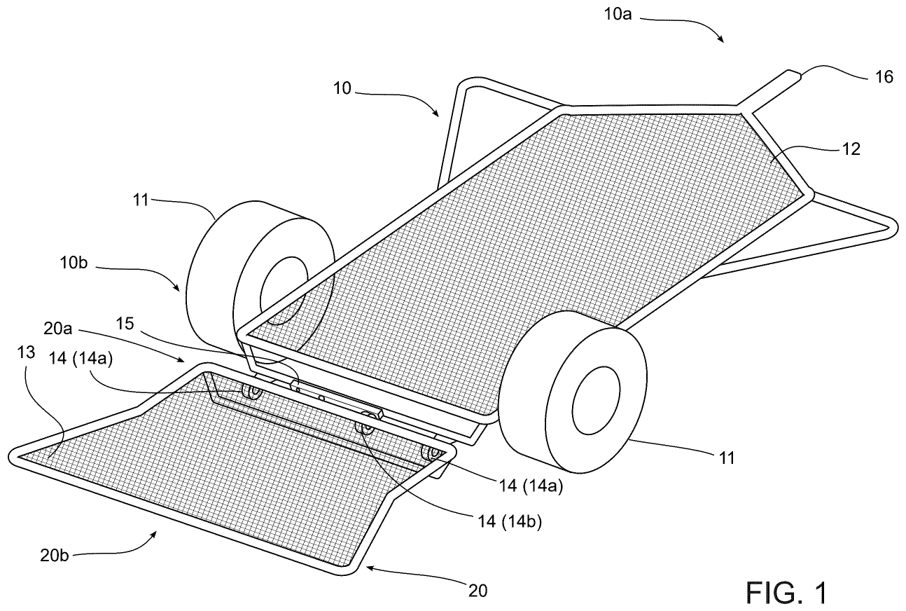

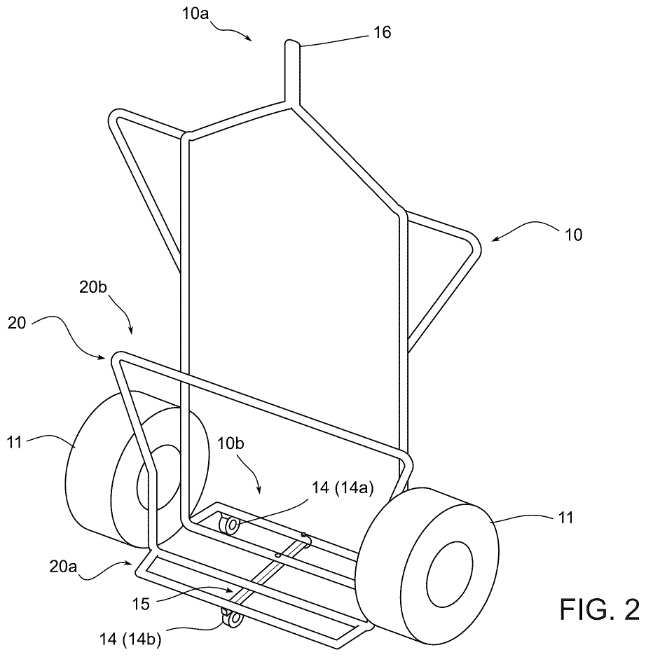

Referring to FIG. 1, a perspective view of a simplified foldable trailer 100 is shown. The foldable trailer includes a primary frame 10 and a secondary frame 20. The secondary frame 20 is foldable onto the primary frame 10. Primary wheels 11 are attached to the primary frame 10. The wheels 11 are configured to be the main support for the trailer and are configured to enable movement through their rotation when pulled by the attached vehicle. Primary wheels 11 also support the trailer when folded and allow a user to push the trailer on its folded configuration as shown in FIG. 2. The secondary frame member can be utilized as a ramp to stow vehicles onto the foldable trailer 100.

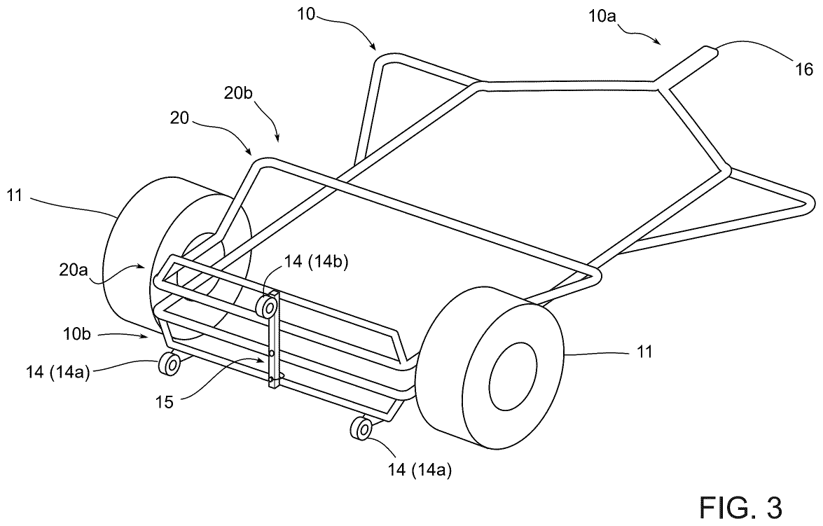

A primary platform 12 is attached to the primary frame 10, while a secondary platform 13 is connected to the secondary frame 20. These platforms 12/13 provide surfaces for carrying objects on the trailer, with the secondary platform 13 contributing additional cargo space when the trailer is unfolded. It should be noted that the primary platform 12 remains accessible and functional even when the trailer is in its folded configuration, allowing for transport of smaller loads as shown in FIG. 3. The platform may be perforated to allow for drainage of liquids, making it suitable for transporting wet or messy cargo.

Referring to FIGS. 1-3, caster wheels 14 are attached to the foldable trailer in order to support the trailer during its folded configuration. As shown in FIG. 2, during the folded configuration the trailer may be set upright when being stored. In one embodiment, the trailer may include a caster wheel 14b placed on a locking support structure 15 and a set of fixed swivel casters 14a that are affixed onto the primary frame 10 of the foldable trailer. These caster wheels 14 are offset from the primary wheels 11 in order to support the foldable trailer in its upright and folded configuration. The locking support structure 15 is configured to lock the foldable secondary frame 20 in its folded configuration as shown in FIGS. 2 and 3. The locking support structure ensures that the secondary frame 20 does not unlock or unfold during movement of the trailer. The foldable trailer 20 may include a trailer tongue 16 configured to connect to a trailer hitch of the vehicle located at the forward end 10a of the primary frame member.

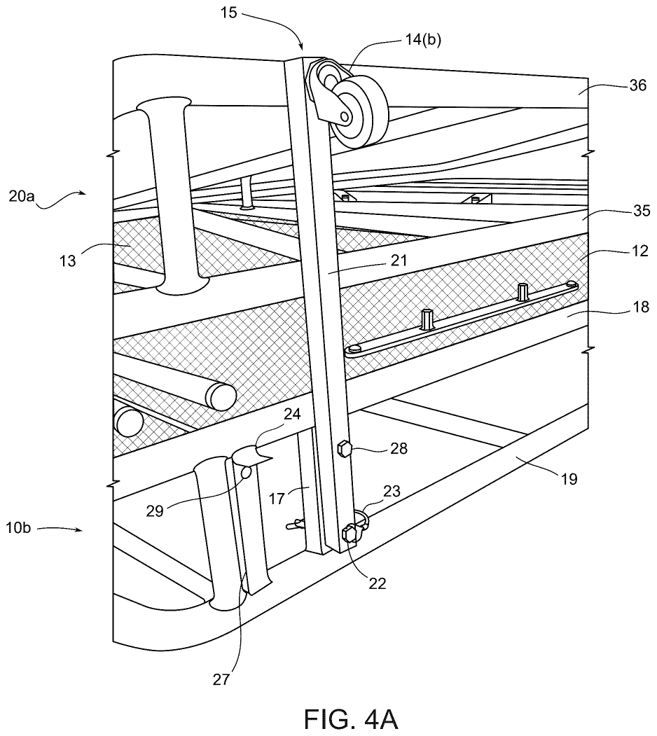

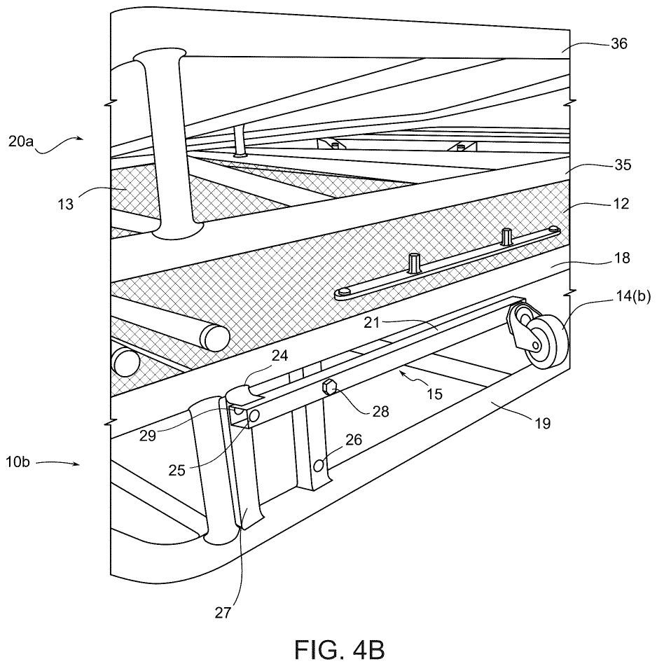

As seen in FIG. 4A a close up of the rear end 10b of the primary frame member and the forward end 20a of the secondary frame member 20 when the trailer is in its folded state. In this embodiment, the locking support structure 15 is in its locking state. The locking support structure may be attached to a first rear vertical primary frame member 17 via a pivoting pin 28. The first rear vertical primary frame member 17 may be connected to a first rear lateral primary frame member 18 and a second rear lateral primary frame member 19. The locking support structure 15 physically blocks the secondary frame member 20 from unfolding. The secondary frame member 20 may include a first forward lateral secondary frame member 35 and a second forward lateral secondary frame member 36. Any forces that act on the secondary frame member 20 that may cause the secondary frame to unfold is blocked by the locking force exerted by top section of the main body 21 of the locking support structure 15. In one embodiment the locking support structure 15 is rotatable relative to the primary frame 10. A locking pin 22 secures the bar in place and ensures the foldable trailer remains locked. The locking pin is configured to be inserted into the main body 21 via main body pin hole 25 and the first vertical frame member 17 via first vertical frame pin hole 26. The locking pin may also include a wire loop 23 configured to be fastened onto the head and the of the pin at one end and the pin shaft at the other end. This configuration secures the pin 22 to both the locking support structure 15 and the first rear vertical primary frame member 17 during the folding configuration of the trailer. As discussed earlier, the locking support structure may include a swivel caster wheel 14b in order to support the trailer in its folded upright position.

Referring to FIG. 4B, the locking support structure 15 is shown in the unlocked position. During this position, a stopper 24 may be located on the primary frame 10, adjacent to a second rear vertical primary frame member 27, in order to hold the locking support structure in place and preventing it from rotating further than desired. The stopper 24 that prevents the main body 21 from rotating completely as shown in FIG. 4B. During the unlocked position (FIG. 4B), the main body pin hole 25 and a second vertical frame pin hole 29 (seen in FIG. 4A) may be inserted with the lock pin 22 in order to keep the locking support structure 15 from rotating away from its unlocked position. In one embodiment, the angle between the locked and unlocked position may be 90^{o}. In one embodiment, the second rear vertical primary frame member 27 is parallel to first rear vertical primary frame member 17. In one embodiment, both the first rear vertical primary frame member 17 and the second rear vertical primary frame member 27 may extend from the first rear lateral primary frame member 18 to the second rear lateral primary frame member 19. In one embodiment, the locking support structure extends all the way to the height of the secondary frame member 20 when folded at its forward end.

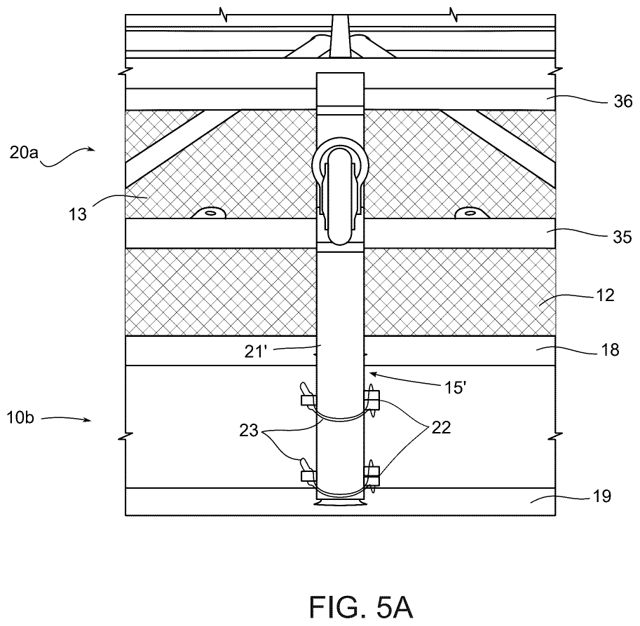

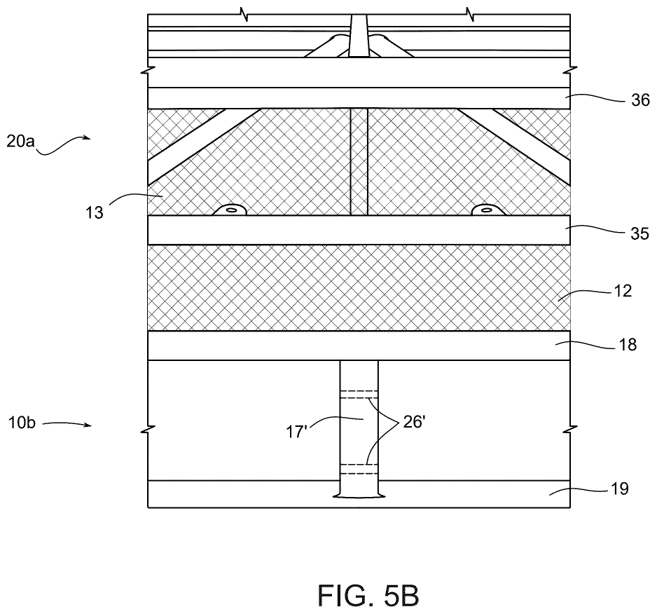

Referring to FIG. 5A, another embodiment is shown for the folding trailer 100′ with locking support structure 15′. In this embodiment, the locking support structure 15′ is a removable component. When the locking support structure is on its locked position (FIG. 5A), locking pins 22 may be utilized to secure the locking support structure 15′ onto rear vertical primary frame member 17′ (See FIG. 5B). In FIG. 5B, the locking support structure 15′ is omitted for clarity and the rear vertical primary frame member 17′ is shown. The rear vertical primary frame member includes pin holes 26′ in order to prevent the locking support structure 15′ from rotating when in the locked position. The pins may also include a wire loop 23 configured to be fastened onto the head and the of the pin at one end and the pin shaft at the other end.

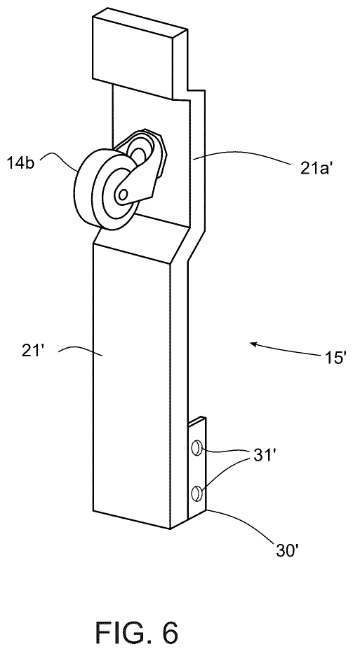

FIG. 6 shows an isolated view of the locking support structure 15′ as shown in the embodiment in FIG. 5A. The locking support structure 15′ may include brackets 30′ configured to extend from the main body 21′ (opposing side not shown). The brackets may include bracket holes 31′ configured to be coaxial and lined up with the corresponding pin holes 26′ in the rear vertical primary frame member 26′. The main body 21′ may include a recessed portion 21a′ that extends within the secondary frame between a first forward lateral secondary frame member 35 and a second forward lateral secondary frame member 36. The caster wheel 14a may be located on the recessed portion 21a′.

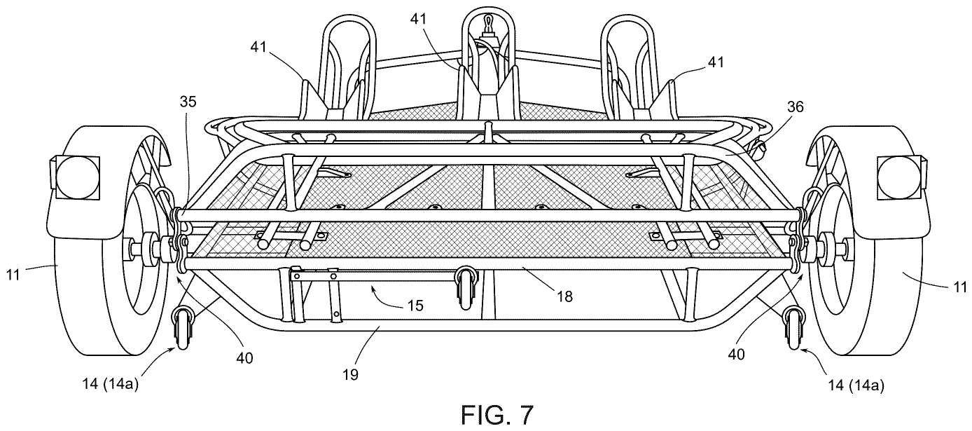

Referring to FIGS. 7-9, a detailed rear view of the trailer 100/100′ is shown. The foldable trailer includes a hinge 40 connecting the first forward lateral secondary frame member 35 and the first rear lateral primary frame member 18. The hinge 40 allows the secondary frame member to fold and unfold. Primary wheels 11 and caster wheels 14b may be attached to the primary frame 10. The trailer may also include one or more wheel chocks 41. Wheel chocks are used to secure wheels of a vehicle, such as an ATV or motorcycle, to keep them upright and stable during transport on the trailer. The wheel chocks 41 are configured to cradle the wheels of the motorcycle and prevent it from moving side-to-side or tipping.

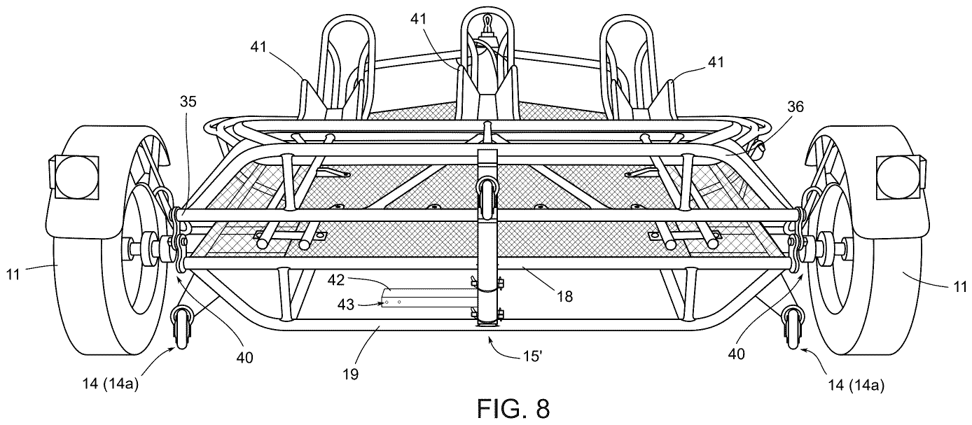

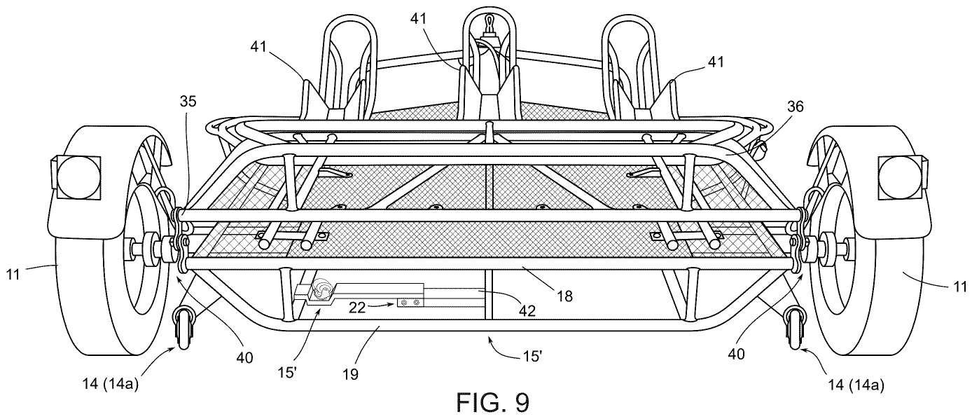

FIGS. 8 and 9 shows a locking support stow member 42 extending from the primary frame. The stow member 42 is configured to be utilized when the locking support structure 15′ is in its unlocked state. The stow member includes one or more pinhole 43 which correspond and are coaxial to the pin holes. In FIG. 9, the rear vertical primary frame member 17′ has been omitted for clarity. The same locking pins 22 may be utilized during this stowed position. During this stowed position, the locking support structure 15′ may extend from the stow member 42 to a portion of the primary frame.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

What is claimed is:

1. A foldable trailer comprising:
a primary frame and a primary platform attached to the primary frame, wherein the primary frame includes a forward primary frame member, a rear lateral primary frame member, and a rear vertical primary frame member, wherein the forward primary frame member is configured to attach to a vehicle trailer hitch;
a secondary frame and a secondary platform attached to the secondary frame, wherein the secondary frame includes a forward lateral secondary frame member, where the forward lateral secondary frame member is parallel to the rear vertical primary frame member;
a hinge connected to the rear vertical primary frame member and the forward lateral secondary frame member thereby connecting the primary frame and the secondary frame, wherein the secondary frame folds onto the primary frame;
a locking support structure comprising swivel caster attached to a main body, wherein said locking support structure configured to be fastened onto the rear vertical primary frame member portion at said end on a first end of the of the locking support structure and wherein said locking support structure is configured to lock the secondary frame by abutting the forward lateral secondary frame member and unlock the second portion by adjusting the main body away from the forward lateral secondary frame member; and
the locking support structure configured to support the primary and secondary frame and allows the foldable trailer to be movable when the foldable trailer is upright.

2. The foldable trailer of claim 1, wherein the locking support structure comprises at least one pin hole configured to receive a removable pin, said pin configured to secure the locking support structure in its locked state.

3. The foldable trailer of claim 1, wherein the locking support structure is rotatable relative to the rear vertical primary frame member.

4. The foldable trailer of claim 3, wherein the primary frame further includes a stopper configured to abut the locking support structure when the locking support structure is in an unlocked state.

5. The foldable trailer of claim 4, wherein said rear vertical primary frame member is a first rear vertical primary frame member;
a second rear vertical primary frame member;
wherein the main body includes a main body pin hole;
when the locking support structure is in the unlocked state, the main body pin hole is configured to receive removable a pin, wherein said pin extends through the main body pin hole and the second rear vertical frame member via a second rear vertical frame member pin hole.

6. The foldable trailer of claim 5, wherein said first rear vertical primary frame member further includes a first rear vertical primary frame member pin hole, wherein during the locked state, said pin extends though the main body pinhole and the first rear vertical primary frame member pin hole to secure the main body in the locked state.

7. The foldable trailer of claim 1, wherein the locking support structure is removable to the rear vertical primary frame member.

8. The foldable trailer of claim 1, wherein the locking support structure is stowed on either of said primary frame or secondary frame when in the unlocked position.

9. The foldable trailer of claim 8, further comprising a stow member, wherein the stow member extends from the primary frame, and wherein the locking support structure extends from the stow member to the primary frame.

10. The foldable trailer of claim 1, wherein the secondary frame is configured to be a ramp to the primary frame.

11. A foldable trailer comprising:
a primary frame and a primary platform attached to the primary frame, wherein the primary frame includes a forward primary frame member, a first rear lateral primary frame member, a second rear lateral primary frame member and a rear vertical primary frame member extending between the first rear lateral and the second rear lateral primary frame members, wherein the forward primary frame member is configured to attach to a vehicle trailer hitch;
a secondary frame and a secondary platform attached to the secondary frame, wherein the secondary frame includes a first forward lateral secondary frame member, a second forward lateral secondary frame member;
a hinge connected to the first rear lateral primary frame member and the first forward lateral secondary frame member thereby connecting the primary frame and the secondary frame, wherein the secondary frame folds onto the primary frame;
a locking support structure comprising swivel caster attached to a main body, wherein said locking support structure configured to be fastened onto the rear vertical primary frame member at said end on a first end of the of the locking support structure and extend towards the second forward lateral secondary frame member, wherein said locking support structure is configured to lock the secondary frame by abutting the second forward lateral secondary frame member and unlock the second portion by adjusting the main body away from the second forward lateral secondary frame member; and
the locking support structure configured to support the primary and secondary frame and allows the foldable trailer to be movable when the foldable trailer is upright.

12. The foldable trailer of claim 1, wherein the locking support structure comprises at least one pin hole configured to receive a removable pin, said pin configured to secure the locking support structure in its locked state.

13. The foldable trailer of claim 1, wherein the locking support structure is rotatable relative to the rear vertical primary frame member.

14. The foldable trailer of claim 3, wherein the primary frame further includes a stopper extending from the first rear lateral primary frame member, said stopper configured to abut the locking support structure when the locking support structure is in an unlocked state.

15. The foldable trailer of claim 4, wherein said rear vertical primary frame member is a first rear vertical primary frame member;
a second rear vertical primary frame member extending between the first rear lateral and the second rear lateral primary frame members;
wherein the main body includes a main body pin hole;
when the locking support structure is in the unlocked state, the main body pin hole is configured to receive removable a pin, wherein said pin extends through the main body pin hole and the second rear vertical frame member via a second rear vertical frame member pin hole.

16. The foldable trailer of claim 5, wherein said first rear vertical primary frame member further includes a first rear vertical primary frame member pin hole, wherein during the locked state, said pin extends though the main body pinhole and the first rear vertical primary frame member pin hole to secure the main body in the locked state.

17. The foldable trailer of claim 1, wherein the locking support structure is removable to the rear vertical primary frame member.

18. The foldable trailer of claim 1, wherein the locking support structure is stowed on either of said primary frame or secondary frame when in the unlocked position.

19. The foldable trailer of claim 8, further comprising a stow member, wherein the stow member extends from the primary frame, and wherein the locking support structure extends from the stow member to the primary frame.

20. The foldable trailer of claim 1, wherein the secondary frame is configured to be a ramp to the primary frame.
